(19) United States
(12) Patent Application Publication
(10) Pub. No.: US 2005/0268049 A1
(43) Pub. Date: Dec. 1, 2005

(54) Dynamic memory management

(75) Inventor: Alphonsus Anthonius Jozef De Lange, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/525,486

(22) PCT Filed: Jul. 24, 2003
(86) PCT No.: PCT/IB03/03334

§ 371 Date: Feb. 23, 2005

(30) Foreign Application Priority Data
Aug. 30, 2002 (EP) 02078566.3

(51) Int. Cl. G06F 12/00

(52) U.S. Cl. 711/149; 711/159

(57) ABSTRACT

The present invention relates to a memory management system for allocating memory in a memory space according to amounts of memory requested by a client, said memory space comprises a number of equally sized containers, and at least some of said containers comprise a number of equally sized sub containers. The system comprises means for generating a memory block, wherein the size of said memory block is selected between a number of predefined sizes, where the selected size is at least equal to said amount of memory requested by the client. The system also comprises means for allocating memory for said memory block in a container, the container being the smallest container having a size being at least twice the size of the memory block.

The present invention relates to a memory management system for allocating memory in a memory space according to amounts of memory requested by a client. The invention also relates to a method of allocating memory in a memory space. Further, the invention relates to an operating system embodied on a computer readable medium comprising a method of managing memory. The invention also relates to a computer readable medium, comprising an algorithm for performing a method of managing memory, and to an embedded real-time software system comprising a method of managing memory. Finally, the invention also relates to a file system comprising a method of managing memory.

Computer programs are typically algorithms that manipulate data to compute a result. A block of memory to store data must first be allocated before the data can be manipulated. When the data is no longer needed, the block of memory is deallocated or freed. Allocation and deallocation of the block of memory are commonly referred to as memory management.

Memory management is performed by an allocator administrating the memory by keeping track of memory blocks that are in use or that are free, and by doing this as quickly as possible. The ideal allocator allocates and frees blocks of memory wasting no space and time.

A conventional allocator cannot compact memory and once it has decided which block of memory to allocate, it cannot change that decision. Consequently, the block of memory must be regarded as inviolable until the program that requested the block chooses to free it. In fact, an allocator can only deal with memory that is free. A conventional allocator is therefore an “online” algorithm that must respond to requests immediately, and its decisions are irrevocable.

For the case of a conventional allocator, it has been proven that for any possible allocation algorithm, there will always be the possibility that some application program will allocate and deallocate blocks in a way that defeats the allocator's strategy, and forces it into severe fragmentation. When some of the characteristics (with regard to memory requests) of the memory users are known, the memory allocator can be “tuned” for these specific requests. This tuning can decrease fragmentation problems. Also, a combination of dynamic and static allocation and the use of certain algorithms can reduce fragmentation, unfortunately introducing memory overhead and CPU-time consumption.

Dynamic memory management introduces four new issues in addition to static memory usage, namely:
External fragmentation
Internal fragmentation
Memory overhead (table fragmentation)
Real time Performance issues

Internal fragmentation can be accepted as part of a strategy to prevent external fragmentation. E.g. in embedded software, external fragmentation is not allowed because this may get worse over time, virtually reducing the amount of memory.

Memory overhead is often caused by bookkeeping. Tables are often used for this and therefore it is often referred to as table fragmentation. These tables can for instance be static lists, containing free blocks, or lookup tables. Memory overhead in the form of tables is very predictable because it is static.

An allocator must respond as fast as possible to requests of the memory users. The number of allocations and deletions can be very large in for example a C++ environment and therefore, it is desirable that the algorithms that are being used are very fast. In general, bad real time allocation performance is due to searching of specific free lists to find a suitable block of memory. In the case of freeing a block of memory, the time is generally being used for looking for the identity (e.g. size) of the block, since for a conventional allocator, only a pointer is passed for deletion.

A trade-off has to be made between these four issues of dynamic memory management. For instance low internal- and external fragmentation can be achieved at the expense of worse timing performance and visa versa. An example of this is a compacting memory allocator where (in theory) no fragmentation occurs, but the algorithms used are more (time) complex. Conversely, an (almost) absence of a memory allocation strategy (i.e. by laying down blocks consecutively in the memory) brings about good real time performance, but very bad fragmentation figures.

The most straightforward strategy is a sequential fit. There are several implementations of this strategy namely first, next, best and worst fit. Because blocks are not rounded to a predefined value, no memory loss due to rounding, also called “internal fragmentation”, is introduced. Another advantage of this method is its simplicity. However, severe fragmentation can occur and the fact that the accompanying free list is searched to find a suitable block is a quite time consuming operation.

Another strategy is to use the “segregated free lists”. Two implementations are known, namely quick- and fast fit. This strategy also suffers from external fragmentation and because all sizes cannot be supported, rounding loss is introduced as well. However, this method is very fast because no free lists have to be searched.

Another very frequently used strategy is the buddy system. For this strategy there are also several implementations, namely the binary, the Fibonacci, the weighted and the double buddy system. The advantages of the binary buddy system are fast coalescing of (buddy-) blocks and simple administration. The main drawback of this method is the poor utilization of memory because the rounding is very coarse, introducing a lot of internal fragmentation. The binary buddy system suffers from external fragmentation as well. Also, a header per block is necessary for management purposes. The Fibonacci buddy system more or less has the same drawbacks as the binary system. However, internal fragmentation is reduced because the values of the Fibonacci series do not grow as fast as values that are a power of two. An additional disadvantage is the fact that calculation of a buddy is more expensive. Another possible disadvantage of Fibonacci buddies is that when a block is split to satisfy a request for a particular size, the remaining block is of a different size, which is less likely to be useful if the program allocates many objects of the same size. The weighted and double buddy systems have the same drawbacks as the binary buddy system, but too have the advantage of having a smaller intra-block difference.

A totally different dynamic memory management approach is the compacting handle based strategy. There is no question of internal fragmentation because blocks are not rounded. Emerging external fragmentation is solved during runtime by means of compaction. However, because of this compaction, no real-time predictable performance can be guaranteed. Also, a level of indirection is introduced. Due to this indirection memory overhead is introduced as well.

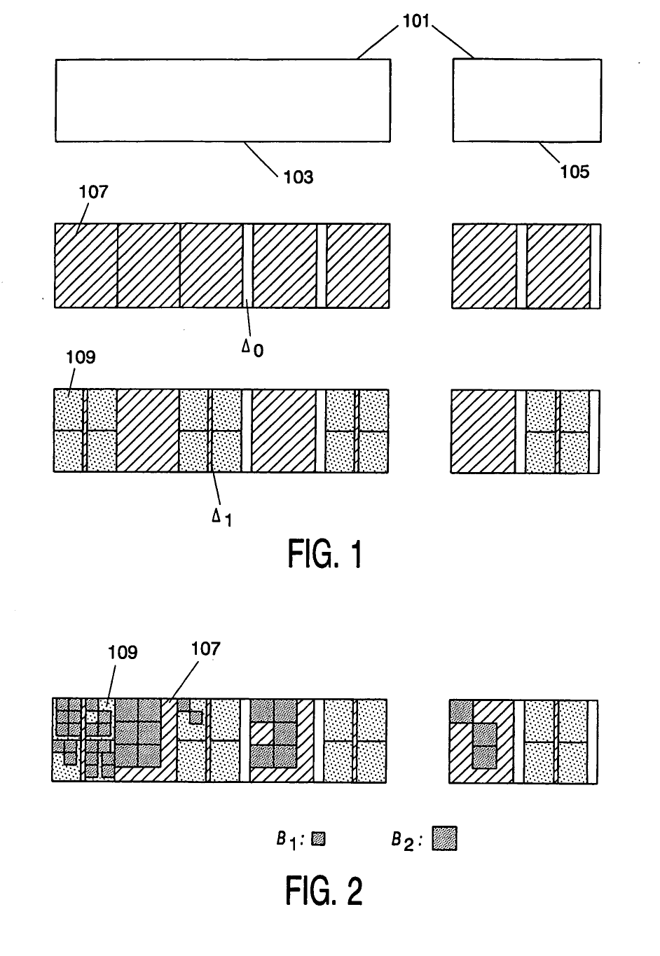

Another method of managing memory is by subdividing the memory space into smaller parts, all of the same size, called containers. Within a container, memory blocks requested by a client, are allocated. Here each container holds blocks of only one particular size. The advantages of this approach are firstly that allocation and deallocation are fast; internal fragmentation is very low and secondly that no external fragmentation is introduced due to the equally sized containers. As a result, a very reliable way of dynamic memory management for embedded real-time systems is offered. The method, however, also has a big drawback: there is only one container size available that should be chosen such that it is optimal for efficiently holding blocks of different sizes (within one container all blocks have same size). If the range of block sizes is wide, optimisation is impossible. As a circumvention of the drawbacks two different container sizes are proposed for a specific product realization: one to hold small blocks (<1 Kb) and one to hold large blocks (>1 Kb, <64 Kb). Next, if block sizes vary considerably, then the two container sizes are not enough to achieve efficient memory utilization. Finally, the solution also requires the complete memory address space to be subdivided in two parts: one part holding small containers and another part holding large containers, see FIG. 1. As a result, the solution only works if all requested block sizes are known in advance.

It is an object of the present invention to perform memory allocation in an improved way.

This is obtained by a memory management system for allocating memory in a memory space according to amounts of memory requested by a client. The memory space comprises a number of equally sized containers, and at least some of the containers comprise a number of equally sized sub containers. The system further comprises means for generating a memory block, wherein the size of said memory block is selected between a number of predefined sizes, where the selected size is at least equal to said amount of memory requested by the client. Further, the system comprises means for allocating memory for said memory block in a container, the container being the smallest container having a size being at least twice the size of the memory block.

The memory allocation proposed by the memory management system according to the present invention can be optimized by tuning the sizes of the containers and the number of container sizes. Furthermore, the multi-level, nested container principle proposed by this invention accepts a very wide range of block sizes, hence will work directly in all practically situations without a-priori knowledge of block sizes. Moreover, the number of container levels and sizes can be configured dynamically at start-up by first requesting the available memory space and subdividing it a number of times. Finally, having a very big, top level container size will have little influence on the allocation behaviour of small blocks, since their allocation behaviour is predominantly determined by the smallest defined container size. At any container nesting level, containers have an equal size. The advantage is that repetitive allocation and de-allocation of any container or sub container will not introduce fragmentation of the memory space, because any hole in the memory space caused by de-allocation of one or several containers is exactly large enough to fit exactly the same number of any newly allocated containers at this level in the container hierarchy, without loss of memory space. The size of containers and blocks can be chosen such that memory utilisation is maximised. By making a memory allocation profile for an embedded system, optimisation of container and block sizes is possible.

In an embodiment, the sub container is placed in a container having a size being at least twice as small as the container.

The goal of introducing sub-containers is to increase memory utilization efficiency. Namely, memory requests of (rounded to) a particular block-size should fill at least a complete container of a particular size, leaving very little space to spare compared to the space occupied by the blocks in the container. If, for a particular block size, there is no single container that is completely filled, while there are a significant number of blocks of this particular size allocated inside this container, then the container size is apparently chosen too big. This is undesirable because much space in the container is not used. In this case, it is useful to introduce a smaller container. It is, however, of no use when this smaller container only fits one time inside the current container because the remaining space cannot be reused anymore by another container, since at any nesting level, containers have equal size. Furthermore, since each container typically has a header holding some information about its contents, it is more efficient to have more than 2 sub-containers per container. The same holds for the number of blocks in a container. As mentioned before, the efficiency is heavily determined by the filling of containers by blocks of a particular size; hence containers should not be too large either.

In a specific embodiment, a container is dedicated for equally sized memory blocks. Thereby memory blocks within a container all have equal size assuring that repetitive allocation and de-allocation of blocks within a container do not give rise to fragmentation within the container. It is guaranteed that any space freed-up in a container will be exactly large enough to fit a new allocation request. Next, de-allocation is fast, because for a particular memory address, only the associated container needs to be found, which then has information in its header about the size of the blocks it contains. The length of this search is determined by the container nesting level, which is very limited (typically smaller than 4) even for a very large range of block sizes (e.g. ranging from 32 bytes to 200 Kbytes).

In an embodiment, the size of the largest container has been selected in such a way that when filling the memory space with said largest containers the remaining area, being smaller than said largest container, has a size which is significantly smaller than said largest container. By subdividing the memory space into containers, one should choose the container size such that the remaining space—which is too small to fit another container of this size—is as small as possible. If this remaining space is nearly as big as a full container, this is clearly not very efficient. Note, however, that this is not always necessarily true if the largest container size is very small compared to the full memory space, e.g. maximum container size is 65306 bytes fitting 256 times a memory space of 16 MB and leaving 58880 bytes unused (0.3% loss).

In another embodiment, the size of the sub container being placed in a container has been selected in such a way that when filling the container with said sub containers the remaining area being smaller than said sub container has a size, which is significantly smaller than said sub container. When choosing particular container sizes, including some reservation for headers, it is not always possible to choose the size of sub-containers such that a multiple of this size fits exactly into a higher-level container size. This is no problem whatsoever. However, when the sizes of sub-containers are chosen such that some space in the higher-level container is just too small to fit another sub-container, the space of nearly a full sub-container is lost. Clearly, it is not very efficient if only a few sub-containers can fit into a larger container.

The invention also relates to a method of allocating memory in a memory space according to amounts of memory requested by a client, said memory space comprises a number of equally sized containers, and at least some of said containers comprise a number of equally sized sub containers, said method comprises the steps of:
generating a memory block, wherein the size of said memory block is selected between a number of predefined sizes, where the selected size is at least equal to said amount of memory requested by the client,
allocating memory for said memory block in a container, the container being the smallest container having a size being at least twice the size of the memory block.

The invention also relates to an operating system embodied on a computer readable medium, the operating system comprising a method of managing memory according to the above.

The invention also relates to a computer readable medium comprising a method of managing memory according to the above.

The invention also relates to an embedded real-time software system comprising a method of managing memory according to the above. The system is very well suited in real-time environments, because of the fast allocation and de-allocation strategy and the performance predictability.

The invention also relates to a file system comprising a method of managing memory according to the above. A file system can map requests of different sizes to different partitions on a disk to optimise the performance of read/write accesses. This is useful for streaming data such as audio and video that must be recorded and played back to/from a disk.

In the following preferred embodiments of the invention will be described referring to the figures, where

FIG. 1 illustrates an example of a memory space according to the present invention,

FIG. 2 illustrates a simple example illustrated where 2 sizes of memory blocks B₁, B₂ are placed in the containers of the memory space illustrated by FIG. 1,

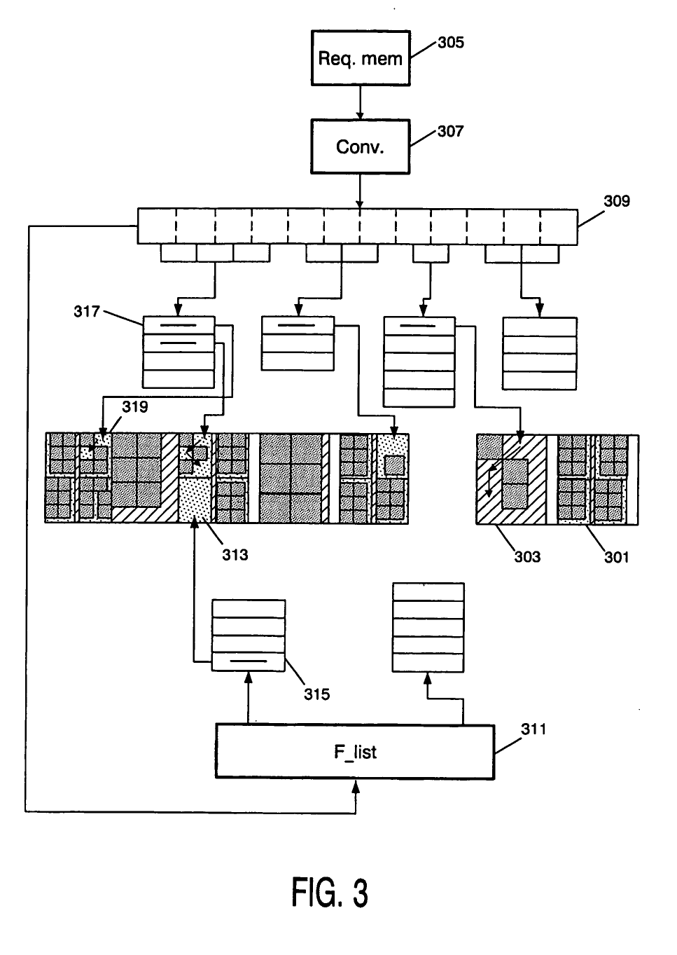

FIG. 3 shows an example of the global functional structure of an allocator with two container-sizes wherein the smaller container is a sub container of the larger container,

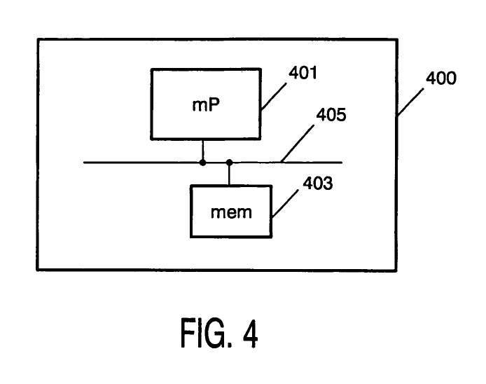

FIG. 4 illustrates an embodiment of a memory management system according to the invention.

The current invention describes the memory space that is available for dynamic allocation by clients as a hierarchy of stacked containers. In this approach, all the available memory space is subdivided in equally sized containers. Each container then either holds blocks of a specific size as requested by a client or multiple sub containers of a smaller size. In a preferred embodiment and in order not to waste memory space, the size of a large container comprising sub containers should have a size being a multiple of the smaller sized sub containers.

The size of allocated blocks is determined by a client and can therefore not be chosen to optimally fit multiple times in a container of a particular size. However, it can be shown that highly memory efficient allocation can be achieved if the size of blocks is small compared to the container in which they are contained.

A specific method of describing the memory space according to the present invention is by the following:

The total allocable memory space is denoted by M, then a set of containers Cᵢ i=0, 1, 2, . . , is chosen such that:
nᵢεN,nᵢ≧2,i=0,1,2,3, . . . ,
n₀C₀+Δ₀=M,Δ₀<<C₀,
nᵢ₊₁Cᵢ₊₁+Δᵢ₊₁=Cᵢ,Δᵢ₊₁<<Cᵢ₊₁,

The formulas express that in the range of container sizes, a smaller sub container should at least fit two times in a larger container. Also, possibly wasted space Δᵢ should be significantly smaller than the size of the smaller sub container.

The memory blocks being allocated in the memory space should be placed in the containers according to the following:

Memory blocks of k different sizes Bₖ, k=0, 1,2, . . . are fitted into a container Cᵢ if,
lₖεN,lₖ≧2, k=0,1,2,3, . . . ,
Bₖ₊₁<Bₖ,
Cᵢ₊₁<2Bₖ,
lₖBₖ+δₖ=Cᵢ,δₖ<<Bₖ

The same is expressed for blocks fitting into containers. Moreover, a block will only be put in a specific container if it is too big to fit at least two times in a smaller sized container, and if the wasted space δₖ in the container is significantly smaller than the size of this block.

As soon as a client requests an amount of memory corresponding to the allocation of a block Bₖ, it is checked in which container it should be placed.

In FIG. 1, an example of a memory space according to the present invention is illustrated. The memory space 101 could either be a contiguous piece of memory or it could comprise contiguous chunks of memory as illustrated by 103 and 105. The memory space is then divided into a number of equally sized containers 107, where the size C₀ of the containers should be chosen in such a way that wasted space Δ₀ is significantly smaller than the size of the containers 107. Some of the containers are then divided into a number of equally sized sub containers 109, where the size C₁ of the sub containers should be chosen in such a way that wasted space Δ₁ is significantly smaller than the size of the sub containers.

In FIG. 2, a simple example is illustrated where memory blocks of sizes B₁, B₂ are placed in the containers of the memory space illustrated by FIG. 1. The smallest blocks of size B₂ are placed in the containers 109 of size C₁, while the larger blocks B₁ will be placed in the containers 107 of size C₀.

FIG. 3 shows an example of the global functional structure of an allocator with two container-sizes wherein the smaller container 301 is a sub container of the larger container 303. When an amount of memory is requested 305, the amount is checked in 307 and may be pre-rounded in such a way that subsequent rounding to a particular block size can be done faster. The first step in the allocation process is the determination of the appropriate block size to which this request must be rounded. In 309 determination of the appropriate block size is performed by means of a look-up table, a hash table or any other method that implements efficient selection of a particular block size for a given allocation request. Next in 311, the appropriate container size is determined for the given block size. Also, this can be done using a look-up table, a hash table or a simple algorithm that uses the criteria described above i.e., if the requested block size is at least twice as small as a particular container size, the block of memory will be fetched from an available container of this size, otherwise the block is taken from the larger container. Requests greater than the largest container size are not supported and result in an exception.

When the first request takes place and no container has been allocated yet, a new container of the largest size will be allocated and will be added to the list of “free” containers of this size. This action also occurs if all previously allocated containers of this size are filled or reserved for a different block size. The allocation of new containers on request can be considered as incremental formatting of the memory space.

Alternatively, it is also possible first to subdivide the complete memory space into the “largest” container size C₀ and put pointers to the starting positions of these in a “free container list” of size C₀. Once a container is used to serve an allocation request, it is removed from its corresponding free list. If a container of a different size must be selected, then the free list of containers of that size is used to fetch a free container. If this free list is empty, then a free container of a larger size is selected, removed from its free list and subdivided into free containers of the next smaller size. All, except one, of these smaller containers are then subsequently put in the free container list of that particular container size. Note that this can be done incrementally with each next request, such that predictable performance can be guaranteed. One of these smaller containers will now be used to serve the block request. If this container is still too big, it will be subdivided again and again, similar to what is described above.

Finally, when a container of the appropriate size has been found and allocated, it is (virtually) subdivided into pieces, just big enough to hold an individual block. Now a free list will be created for this block size. The free list does not need to contain all start positions of all “free” blocks in the container. These can also be added incrementally during allocation/de-allocation sequences, just as can be done for “free” container lists. If for a particular block size any free list exists, then no container allocation and formatting is required.

FIG. 3 shows the situation when just one container size 313 is still empty, hence only for this container size there is still a free container list 315 holding one item. All other free lists for free containers of other sizes are empty, they no longer exist. Still, there are a number of free lists 307 for blocks of different sizes. In an embodiment, as illustrated in FIG. 3, empty blocks within a container e.g. 317 are linked. In this way, a certain container is completely used up before another container is applied and empty blocks can easily be identified.

FIG. 4 illustrates an embodiment of a memory management system 400 for allocating memory in a memory space according the above described. The system comprises a microprocessor 401 connected to a memory module 403, comprising the memory space, via a communication bus 405. The microprocessor then performs the memory allocation in the memory space according to the allocation algorithm stored in the memory module 403.

1. A memory management system for allocating memory in a memory space according to amounts of memory requested by a client, said memory space comprises a number of equally sized containers, and at least some of said containers comprise a number of equally sized sub containers, said system further comprises:
means for generating a memory block, wherein the size of said memory block is selected between a number of predefined sizes, where the selected size is at least equal to said amount of memory requested by the client,
means for allocating memory for said memory block in a container, the container being the smallest container having a size being at least twice the size of the memory block.

2. A memory management system according to claim 1, wherein the sub container being placed in a container has a size being at least twice as small as said container.

3. A memory management system according to claim 1, wherein a container is dedicated for equally sized memory blocks.

4. A memory management system according to claim 1, wherein the size of the largest container has been selected in such a way that when filling the memory space with the largest containers, the remaining area being smaller than said largest container has a size which is significantly smaller than said largest container.

5. A memory management system according to claim 1, wherein the size of the sub container being placed in a container has been selected in such a way that when filling the container with said sub containers, the remaining area being smaller than said sub container has a size which is significantly smaller than said sub container.

6. A method of allocating memory in a memory space according to the amounts of memory requested by a client, said memory space comprises a number of equally sized containers, and at least some of said containers comprise a number of equally sized sub containers, said method comprises the steps of:
generating a memory block, wherein the size of said memory block is selected between a number of predefined sizes, where the selected size is at least equal to said amount of memory requested by the client,
allocating memory for said memory block in a container, the container being the smallest container having a size being at least twice the size of the memory block.

7. A method according to claim 6, wherein the sub container being placed in a container has a size being at least twice as small as said container.

8. A method according to claim 6, wherein a container is dedicated for equally sized memory blocks.

9. A method according to claim 6, wherein the size of the largest container is selected in such a way that when filling the memory space with said largest containers, the remaining area being smaller than said largest container has a size which is significantly smaller than said largest container.

10. A method according to claim 6, wherein the size of the sub container being placed in a container is selected in such a way that when filling the container with said sub containers, the remaining area being smaller than said sub container has a size which is significantly smaller than said sub container.

11. An operating system embodied on a computer readable medium, the operating system comprising a method of managing memory according to claim 1.

12. A computer readable medium comprising an algorithm for performing a method of managing memory according to claim 1.

13. An embedded real-time software system the real-time software system comprising a method of managing memory according to claim 1.

14. A file system comprising a method of managing memory according to claim 1.
